(19) United States
(12) Patent Application Publication
(10) Pub. No.: US 2006/0014107 A1
(43) Pub. Date: Jan. 19, 2006

(54) Method of fabricating ink jet head

(76) Inventors: Sung-Joon Park, Suwon-si (KR); Byung-Ha Park, Suwon-si (KR); Kyong-Il Kim, Seoul (KR)

Correspondence Address: STANZIONE & KIM, LLP, 919 18TH STREET, N.W., SUITE 440, WASHINGTON, DC, 20006, US

(21) Appl. No.: 11/033,373

(22) Filed: Jan. 12, 2005

(30) Foreign Application Priority Data
Jul. 16, 2004 (KR) 2004-55769

(51) Int. Cl. B41J 2/16

(52) U.S. Cl. 430/320; 216/27

(57) ABSTRACT

A method of fabricating an ink jet head. The method includes preparing a substrate having first and second surfaces, the substrate being provided with a plurality of pressure-generating elements disposed on the first surface. A mask pattern having at least one opening is formed on the first surface on which the pressure-generating elements are disposed. The method further includes forming an ink-feed channel that extends through the substrate from the first surface by using the mask pattern as an etch mask. The method is capable of improving yield and reliability of the ink jet head since the shape and dimension of the ink-feed channel may be uniformly and reproducibly adjusted.

### CROSS-REFERENCE TO RELATED APPLICATIONS

This application claims the benefit of Korean Patent Application No. 2004-55769, filed Jul. 16, 2004, the disclosure of which is incorporated herein by reference and in its entirety.

### BACKGROUND OF THE INVENTION

1. Field of the Invention

The present general inventive concept relates to a method of fabricating an ink jet head and, more particularly, to a method of fabricating an ink jet head provided with an ink-feed channel having a uniform and reproducible shape and dimension.

2. Description of the Related Art

An ink jet recording device functions to print an image by ejecting fine droplets of printing ink to a desired position on a recording medium. Ink jet recording devices have been widely used due to the fact that they are inexpensive and are capable of printing numerous colors at a high resolution. Ink jet recording devices typically include an ink jet head to eject ink, and an ink container in fluid communication with the ink jet head. Ink jet heads are generally classified into two categories according to the ink droplet ejection mechanism being used. The first category of ink jet heads is a thermal type, which uses an electro-thermal transducer to generate pressure to eject the ink droplets. The second type of ink jet head is a piezo-electric type, which uses an electromechanical transducer to generate pressure for ink ejection.

The ink jet head includes a silicon substrate provided in a shape of a semiconductor chip, and a number of elements disposed on a top surface of the silicon substrate. An example of the conventional type thermal ink jet head is disclosed in U.S. Pat. No. 4,882,595. The conventional thermal ink jet head has a plurality of heat-generating resistors disposed on the silicon substrate to generate heat energy for ink ejection, a chamber layer defining a sidewall of an ink flow path including an ink chamber and an ink channel, and a nozzle layer disposed on the chamber layer. The nozzle layer has a plurality of nozzles corresponding to the heat-generating resistors, respectively. A bottom surface of the silicon substrate is attached to the ink container, and the ink container supplies ink to the ink jet head through an ink-feed channel passing through the silicon substrate. The ink is supplied from the ink-feed channel to the ink chamber via the ink channel. The ink stored in the ink chamber is instantly heated by the heat-generating resistor to be ejected, in a droplet shape, to the recording medium through the nozzle by the pressure generated by the heat generating resistors. The ink chamber is then refilled with ink supplied through the ink channel.

Generally, the ink jet head should meet the following conditions. First, the manufacturing process of ink jet heads should be simple, manufacturing costs should be low, and mass production should be possible. Second, in order to obtain a high quality image, cross talk between adjacent nozzles should be minimal while the distance between the adjacent nozzles should remain small. That is, in order to increase resolution in dots per inch (DPI), a plurality of nozzles should be arranged with a high density. Third, in order to perform a high-speed printing operation, the period in which the ink chamber is refilled with ink after the ink is ejected out of the ink chamber should be as short as possible, and the cooling of heated ink and the heat generating resistors should be performed quickly to increase the driving frequency.

In order to meet the above-mentioned conditions, various methods have been attempted. For example, various methods of fabricating an ink jet head are disclosed in U.S. Pat. Nos. 6,409,312 and 6,390,606, and Japanese Patent Laid-open Publication No. 2003-89209. In accordance with the conventional methods of fabricating an ink jet head, the ink-feed channel passing through the silicon substrate is formed by etching the silicon substrate from the bottom surface of the silicon substrate. Etching the silicon substrate involves a wet etching process using a strong alkaline solvent such as tetramethtyl ammonium hydroxide (TMAH) as an etchant or a dry etching process such as a sand blasting process. However, the process of forming the ink-feed channel by etching the silicon substrate from the bottom surface may have the following problems.

First, when using wet etching techniques, undercutting tends to occur at a lower portion of the silicon substrate due to a difference in etch selectivity between the silicon substrate and an etch mask formed on the bottom surface of the silicon substrate. In this case, an edge of the etch mask covering the undercut portion may penetrate the ink flow path to serve as an impurity. In order to account for this problem, a separate process for removing the edge of the etch mask after performing the wet etching process becomes necessary. In addition, a separate masking process for protecting structures, such as the heat-generating resistors, previously formed on the top surface of the silicon substrate, is required to protect the structures from the wet etching process, thereby further complicating the process. Using sand blasting and/or dry etching processes to etch the bottom surface of the substrate also present problems since fine sands used in the process may act as particles in the ink jet head, thereby deteriorating the ink ejection properties.

Further, since the wet etching or the dry etching is progressed from the bottom surface toward the top surface of the silicon substrate, the outline of the outlet of the ink-feed channel formed on the top surface of the silicon surface is formed roughly, thus making it difficult to reproducibly control the shape and the dimension thereof. This may cause a distance from the outline of the outlet of the ink-feed channel to each ink channel to become uneven such that the speed with which ink is refilled into the ink chambers, after the ink ejection, may vary. As a result, the ink ejection frequency from each ink chamber may differ. This may cause the ink jet head to become unreliable.

### SUMMARY OF THE INVENTION

The present general inventive concept provides methods of fabricating an ink jet head capable of increasing yield and reliability of an ink jet head by uniformly and reproducibly adjusting the shape and dimension of an ink-feed channel.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a method of fabricating an ink jet head including an ink-feed channel having a uniform and reproducible shape and dimension. The method includes preparing a substrate having first and second surfaces, the substrate being provided with a plurality of pressure-generating elements disposed on the first surface. A mask pattern having at least one opening may be formed on the first surface on which the pressure-generating elements are disposed. An ink-feed channel that extends through the substrate may be formed by dry etching the substrate from the first surface using the mask pattern as an etch mask.

The substrate may be a silicon substrate, and dry etching the substrate may be performed by a reactive ion etching (RIE) process or a deep reactive ion etching (DRIE) process. In addition, the mask pattern may be formed of a silicon oxide layer, a silicon nitride layer, a photoresist layer, a photosensitive resin layer, a metal layer, or a metal oxide layer.

The method may further include removing the mask pattern after forming the ink-feed channel. Once the mask pattern is removed, a chamber layer defining sidewalls of an ink flow path may be formed on the first surface of the substrate. A nozzle layer with a plurality of nozzles corresponding to the pressure-generating elements may then be formed on the chamber layer. The chamber layer may be formed by patterning a photosensitive dry film layer such that the nozzle layer may then be adhered to the chamber layer.

A method of fabricating an ink jet head may include preparing a substrate having first and second surfaces, the substrate being provided with a plurality of pressure-generating elements disposed on the first surface. A mask pattern having at least one opening may be formed on the first surface on which the pressure-generating elements are disposed. Using the mask pattern as an etch mask, the substrate may be partially dry etched from the first surface to form the ink-feed channel in the substrate such that an unetched portion having a predetermined height from the second surface may be left on the substrate. The second surface of the substrate may be polished to remove the unetched portion.

The method may further include removing the mask pattern after forming the ink-feed channel. Once the mask pattern is removed, a chamber layer defining sidewalls of an ink flow path may be formed on the first surface of the substrate. A sacrificial mold layer filling the ink flow path and the ink-feed channel between the sidewalls defined by the chamber layer may then be formed.

After removing the unetched portion, a nozzle layer having a plurality of nozzles corresponding to the pressure-generating elements may be formed on the chamber layer and the sacrificial mold layer. Once the nozzle layer is formed, the sacrificial mold layer is dissolved and removed. The nozzle layer having the plurality of nozzles corresponding to the pressure-generating elements may be formed after forming the sacrificial mold layer. In addition, removing the sacrificial mold layer may be performed after removing the unetched portion.

The chamber layer may also be formed on the first surface of the substrate before forming the mask pattern, and the mask pattern may be formed on the first surface having the chamber layer.

The foregoing and/or other aspects of the present general inventive concept may also be achieved by providing a method of fabricating an ink jet head including preparing a substrate having first and second surfaces, the substrate being provided with a plurality of pressure-generating elements disposed on the first surface. A mask pattern having at least one opening may be formed on the first surface on which the pressure-generating elements are provided. The substrate may be partially dry etched from the first surface to form the ink-feed channel in the substrate such that an unetched portion having a predetermined height from the second surface may be left on the substrate. A sacrificial mold layer may be formed to fill the ink-feed channel and cover the region in which an ink flow path is formed. The second surface of the substrate may be polished to remove the unetched portion.

The method may further include forming a chamber/nozzle layer having a plurality of nozzles corresponding to the pressure-generating elements, while covering sidewalls and a top surface of the sacrificial mold layer, after removing the unetched portion. Once the unetched portion of the substrate is removed, the sacrificial mold layer is dissolved and removed.

The chamber/nozzle layer may be formed after forming the sacrificial mold layer. In addition, removing the sacrificial mold layer may be performed after removing the unetched portion.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a partial plan view of an ink jet head in accordance with various embodiments of the present general inventive concept;

FIGS. 2 to 4 are cross-sectional views, taken along the line I-I′ of FIG. 1, illustrating a method of fabricating an ink jet head in accordance with another embodiment of the present general inventive concept;

FIGS. 5 to 9 are cross-sectional views, taken along the line I-I′ of FIG. 1, illustrating a method of fabricating an ink jet head in accordance with another embodiment of the present general inventive concept;

FIGS. 10 and 11 are cross-sectional views, taken along the line I-I′ of FIG. 1, illustrating a method of fabricating an ink jet head in accordance with another embodiment of the present general inventive concept;

FIG. 12 is a cross-sectional view, taken along the line I-I′ of FIG. 1, illustrating a method of fabricating an ink jet head in accordance with another embodiment of the present general inventive concept; and

FIGS. 13 to 16 are cross-sectional views, taken along the line I-I′ of FIG. 1, illustrating a method of fabricating an ink jet head in accordance with another embodiment of the present general inventive concept.

### DETAILED DESCRIPTION OF THE PREFERRED EMBODIMENTS

The present general inventive concept will now be described more fully hereinafter with reference to the accompanying drawings, in which various embodiments of the present general inventive concept are shown. The present general inventive concept may, however, be embodied in different forms and should not be construed as limited to the embodiments set forth herein. Rather, these embodiments are provided so that this disclosure will be thorough and complete, and will fully convey the scope of the present general inventive concept to those skilled in the art. In the drawings, the thickness of layers and regions are exaggerated for clarity. Like numbers refer to like elements throughout the specification.

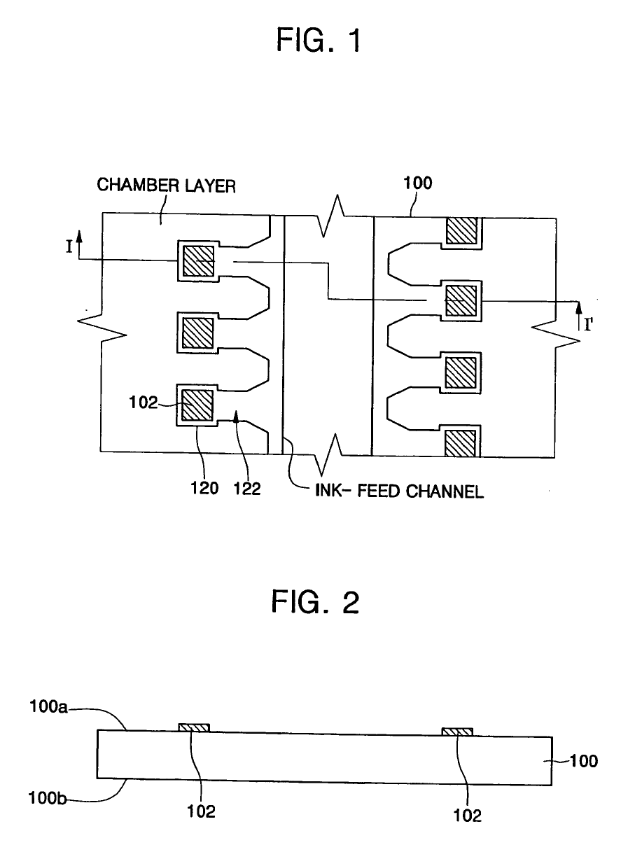

FIG. 1 is a partial plan view of an ink jet head in accordance with various embodiments of the present general inventive concept, and FIGS. 2 to 4 are cross-sectional views, taken along the line I-I′ of FIG. 1, illustrating a method of fabricating an ink jet head in accordance with an embodiment of the present general inventive concept.

Referring to FIGS. 1 and 2, a substrate 100 is prepared. The substrate 100 may be a silicon substrate used in a semiconductor manufacturing process having a thickness of about 500 micrometers (μm). The substrate 100 has a top surface 100a and a bottom surface 100b opposite to the top surface 100a. A plurality of pressure-generating elements 102 to generate pressure for ink ejection may be formed on the top surface 100a of the substrate 100. In accordance with various embodiments of the present general inventive concept, the pressure-generating elements 102 may be heat-generating resistors made of a high resistant metal such as tantalum or tungsten, an alloy such as tantalum aluminum including the high resistance metal, or poly-silicon in which impurity ions are doped. Other pressure-generating elements may alternatively be used. As shown in FIG. 1, the pressure-generating elements 102 may be disposed in, but are not limited to, two rows on the top surface 100a. In addition, as shown in FIG. 1, the pressure-generating elements 102 may be disposed along a straight line, or in a zigzag arrangement.

Other elements may also be formed on the top surface 100a. These other elements may include, for example, wiring to supply electric signals to the pressure-generating elements, conductive pads to electrically connect an external circuit with the pressure-generating elements, a silicon oxide heat barrier formed at the lowermost layer on the substrate 100, and/or a passivation layer to protect the structures described above. The present general inventive concept is not limited to any particular method of forming these components including the pressure-generating elements 102 and materials used therein, and it should be understood that these components may be created by technologies known to those skilled in the art. Therefore, their description will be omitted.

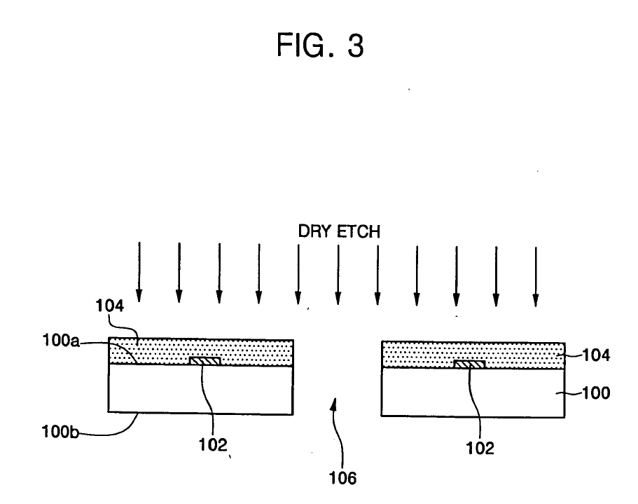

Referring to FIGS. 1 and 3, a mask pattern 104 is formed on the top surface 100a having the pressure generating elements 102. The mask pattern 104 may be formed of a silicon oxide (SiO₂) layer, a silicon nitride (SiN) layer, a photoresist layer, a photosensitive resin layer, a metal layer such as tantalum, or a metal oxide layer such as a tantalum oxide layer. Other materials may alternatively be used for the mask pattern 104. For example, the mask pattern may be formed by forming the silicon oxide layer on the top surface 100a using a chemical vapor deposition method or a spin coating method, then patterning the silicon oxide layer by photo and anisotropic etching processes. In another example, the mask pattern 104 may be formed by applying a photoresist material layer on the top surface 100a using the spin coating method, then patterning the photoresist material layer by a photo process including exposure and developing processes. The mask pattern 104 exposes a predetermined region of the top surface 100a, on which an ink-feed channel may be formed by the following process. Using the mask pattern 104 as an etch mask, the substrate 100 may be dry etched from the top surface 100a toward the bottom surface 100b. As a result, the ink-feed channel 106 that extends through the substrate 100 is formed. The ink-feed channel 106 may be formed to pass through a predetermined region of the substrate 100, on which the pressure-generating elements 102 are not disposed. The ink-feed channel 106 may be formed to have a single slot shape between the pressure-generating elements disposed in two rows as shown in FIG. 1.

In accordance with various embodiments of the present general inventive concept, the substrate 100 may be etched by a reactive ion etching (RIE) process or a deep reactive ion etching (DRIE) process. The DRIE process is also known as an inductive coupled plasma (ICP) process. In particular, the DRIE process may be appropriate to etch the silicon substrate having a thickness of about 500 micrometers (μm) since it is possible to obtain a high aspect ratio by using a highly concentrated plasma source and alternately performing etching and passivation layer deposition. For example, SF₆ gas may be used as an etching plasma source, and C₄F₈ gas may be used as a passivating plasma source.

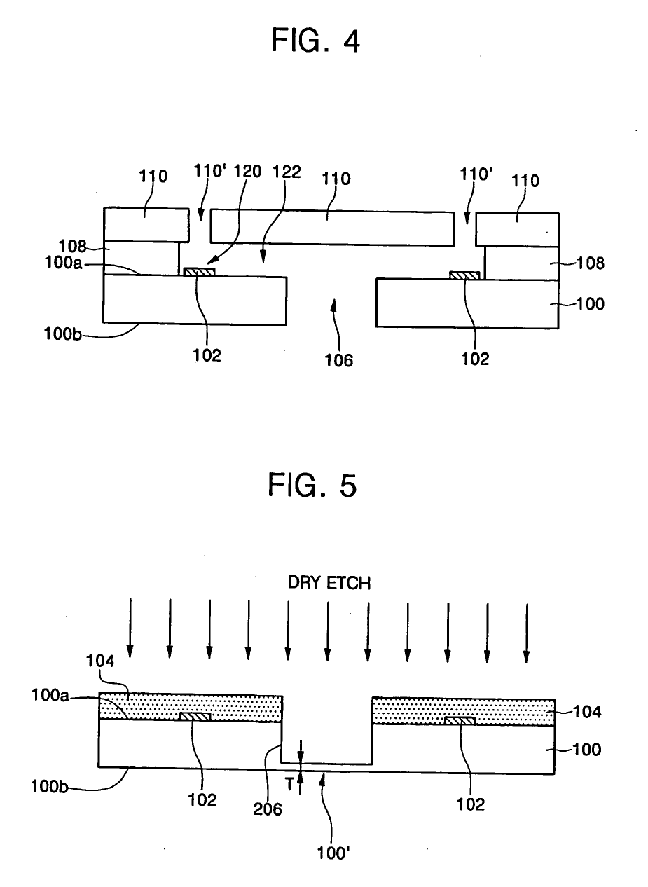

Referring to FIGS. 1 and 4, the mask pattern 104 (see FIG. 3) may be removed. When the mask pattern 104 is formed of a silicon oxide layer, the mask pattern 104 may be removed by a wet etching process using an etchant such as a solvent containing fluorine, for example, buffered oxide etchant (BOE) or fluorine acid (HF). Alternatively, if the mask pattern 104 is formed of a photoresist layer, the mask pattern 104 may be removed by an ashing process using oxygen plasma.

Next, a chamber layer 108 may be formed on the top surface 100a of the substrate 100 having the ink-feed channel 106. The chamber layer 108 may be formed by the following process. First, a photosensitive dry film layer may be applied on the top surface 100a of the substrate 100 by a lamination method, which heats and presses the photosensitive dry film layer. The photosensitive dry film layer may be, for example, a negative photosensitive resin film available from DuPont and sold under the trade name “VACREL” or “RISTON.” The chamber layer 108 defining sidewalls of an ink flow path may be formed by patterning, exposing, and developing the photosensitive dry film layer. A nozzle layer 110 with a plurality of nozzles 110′ may be heated and pressed on the chamber layer 108 and adhered thereto. Each nozzle 110′ may be arranged to be located at a straight upper portion of each of the pressure-generating elements 102. The present general inventive concept is not limited to any particular process of forming the nozzle layer 110, and it should be understood that the nozzle layer may be created by alternative methods known to those skilled in the art. For example, the nozzle layer 110 may be formed by a nickel electroplating process, or a micro punching and polishing process. Ink chambers 120 and ink channels 122 may be formed by forming the nozzle layer 110 on the chamber layer 108. The ink chambers 120 and the ink channels 122 constitute a flow path that the ink takes when being supplied from the ink feed channel 106 formed in the substrate 100 to the pressure generating elements 102 in the ink chambers 120.

As described with reference to FIGS. 1 and 3, the ink-feed channel 106 may be formed by dry etching the substrate 100 from the top surface 100a toward the bottom surface 100b. As a result, shape and dimension of an outline of an outlet of the ink-feed channel 106 defined on the top surface of the substrate 100 can be precisely and reproducibly adjusted. Therefore, a distance from the outline of an outlet of the ink-feed channel 106 to an inlet of each ink channel 122 can be uniformly adjusted such that the speed with which the ink is refilled into the ink chambers 120 (after ejecting the ink) can be uniform. In addition, when dry etching the substrate 100, the problem of undercutting associated with wet etching the bottom surface 100b of the substrate 100 can be avoided. Therefore, the area of the outlet of the ink feed channel 106 on the bottom surface 100b of the substrate 100 is less than it would be if the bottom surface was wet etched in a conventional manner. As a result, when an ink cartridge is adhered to the bottom surface 100b, an area adhered to the ink cartridge increases as much as the area of the outlet of the ink-feed channel 106 is decreased by using dry etching. The increase in area that the ink cartridge is able to adhere to prevents the ink from leaking. Furthermore, when dry etching the substrate 100 from the bottom surface 100b in the conventional manner, notching occurs near the top surface 100a of the substrate 100 due to a difference in etch selectivity between the substrate 100 and an etch stop layer formed on the top surface 100a of the substrate such that it is difficult to control the shape and dimension of the outline of the outlet of the ink-feed channel 106 on the top surface 100a. However, as set forth above, dry etching the substrate 100 from the top surface 100a provides the advantage of avoiding the problems caused by the notching.

FIGS. 5 to 9 are cross-sectional views, taken along the line I-I′ of FIG. 1, illustrating a method of fabricating an ink jet head in accordance with another embodiment of the present general inventive concept.

Referring to FIGS. 1 and 5, as described in FIG. 2, a substrate 100 provided with a plurality of pressure-generating elements 102 is prepared. A mask pattern 104 exposing a region, in which an ink-feed channel 206 is to be formed, may be formed on a top surface 100a of the substrate 100. An ink-feed channel 206 may be formed in the substrate 100 by dry etching the substrate 100 from the top surface 100a using the mask pattern 104 as an etch mask. The substrate 100 may be etched by a reactive ion etching (RIE) process or a deep reactive ion etching (DRIE) process. The dry etching may be partially performed to leave an unetched portion 100′ having a predetermined thickness T from the bottom surface 100b of the substrate 100. That is, the dry etching is progressed until the unetched portion 100′ is left behind. The unetched portion 100′ may have a thickness of about 10˜50 micrometers (μm), for example.

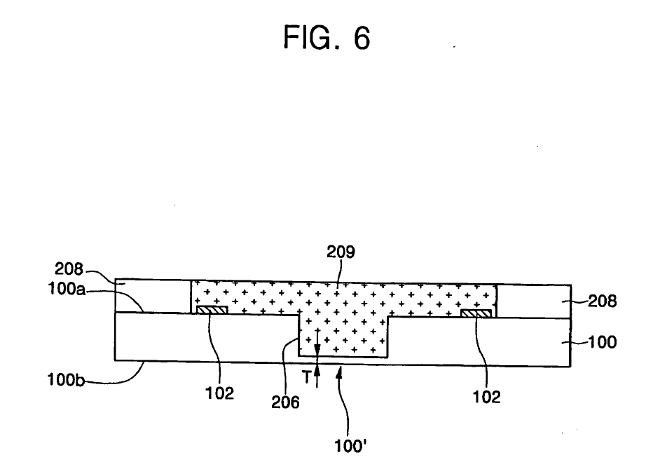

Referring to FIGS. 1 and 6, first, the mask pattern 104 may be removed by wet or dry etching. Once the mask pattern 104 is removed, a chamber layer 208 defining sidewalls of an ink flow path may be formed on the top surface 100a of the substrate 100 having the ink-feed channel 206. The chamber layer 208 may be formed by forming a photosensitive resin layer on the top surface 100a of the substrate 100 and then exposing and developing the photosensitive resin layer. The photosensitive resin layer may be formed by a spin coating method using a liquid photosensitive resin, or by heating and pressing a photosensitive dry film layer through a lamination method. After forming the chamber layer 208, a sacrificial mold layer 209 may be formed between the ink-feed channel 206 and the sidewalls defined by the chamber layer 208 to fill a region in which the ink flow path is to be formed. In particular, a polyimid-based or polyamide-based positive photosensitive resin layer, or a thermoplastic resin layer may be formed by the spin coating method on the top surface 100a of the substrate 100, having the chamber layer 208 thereon. The positive photosensitive resin layer or the thermoplastic resin layer may then be planarized to form the sacrificial mold layer 209 in order to expose the top surface of the chamber layer 208. The planarization may be performed by, for example, a chemical mechanical polishing (CMP) process.

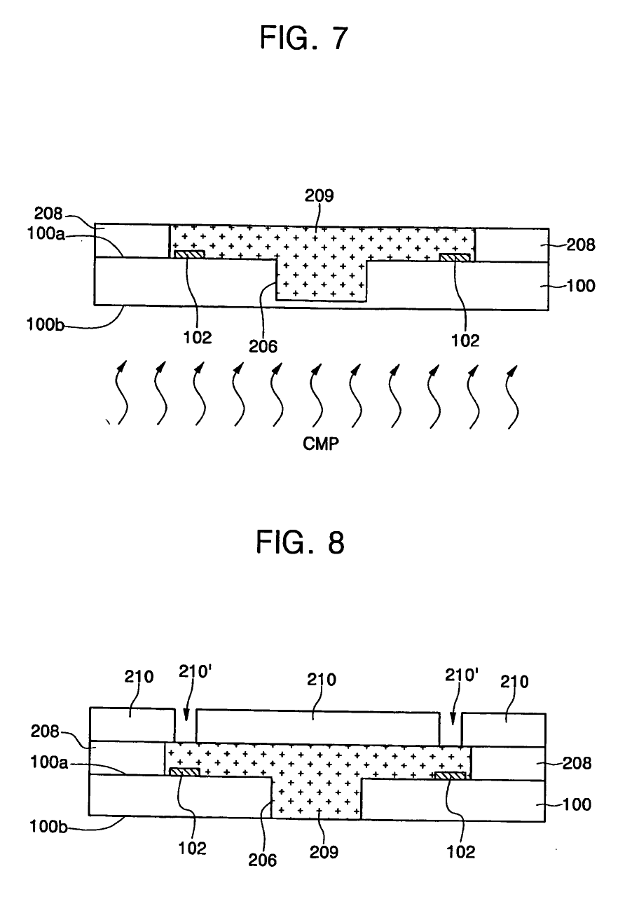

Referring to FIGS. 1 and 7, after forming the sacrificial mold layer 209, the bottom surface 100b of the substrate 100 may be polished by the CMP process to remove the unetched portion 100′ (see FIG. 6). As a result, the bottom surface of the sacrificial mold layer 209 is exposed through the region from which the unetched portion 100′ is removed, and the ink-feed channel 206 extends through the substrate 100.

Referring to FIGS. 1 and 8, after removing the unetched portion 100′, a nozzle material layer may be formed on the chamber layer 208 and the sacrificial mold layer 209. The nozzle material layer may be formed of a negative photosensitive resin layer or a thermosetting resin layer by a spin coating method. The nozzle material layer may be patterned to form a nozzle layer 210 having nozzles 210′ located at a straight upper portion of the pressure-generating elements 102. For example, if the nozzle material layer is formed of the negative photosensitive resin layer, the negative photosensitive resin layer may be patterned by exposing and developing processes using a photo-mask provided with the nozzle pattern. In addition, if the nozzle material layer is formed of the thermosetting resin layer, the thermosetting resin layer may be patterned by a photo process and an anisotropic etching process using oxygen plasma.

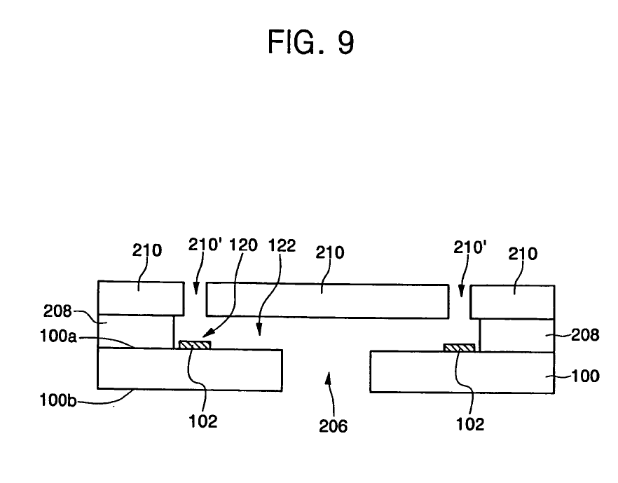

Referring to FIGS. 1 and 9, after forming the nozzle layer 210, the sacrificial mold layer 209 is dissolved and removed. A solvent such as glycol ether, methyl lactate, or ethyl lactate may be used to remove the sacrificial mold layer 209. As a result of removing the sacrificial mold layer 209, the ink flow path including the ink chamber 120 and the ink channel 122 is formed in the region from which the sacrificial mold layer 209 is removed.

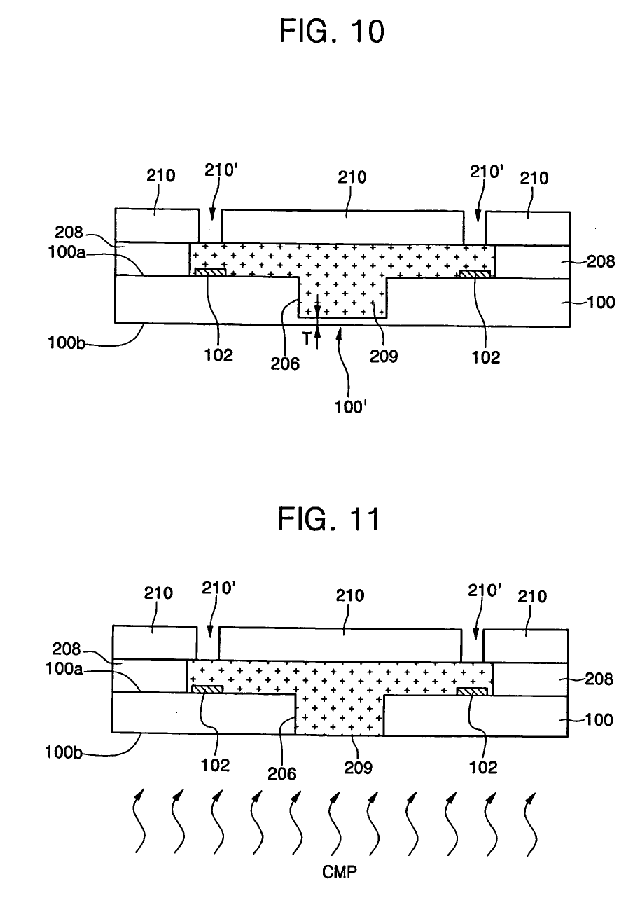

FIGS. 10 and 11 are cross-sectional views, taken along the line I-I′ of FIG. 1, illustrating a method of fabricating an ink jet head in accordance with another embodiment of the present general inventive concept.

Referring to FIGS. 1, 10 and 11, the CMP process described in FIG. 7 may be performed after forming the nozzle layer 210. That is, after performing the processes described in FIGS. 5 and 6, the nozzle layer 210 having nozzles 210′ corresponding to the pressure-generating elements 102 may be formed on the chamber layer 208 and the sacrificial mold layer 209 prior to performing the CMP process. As shown in FIG. 11, the CMP process may then be performed to remove the unetched portion 100′, and the sacrificial mold layer 209 is dissolved and removed.

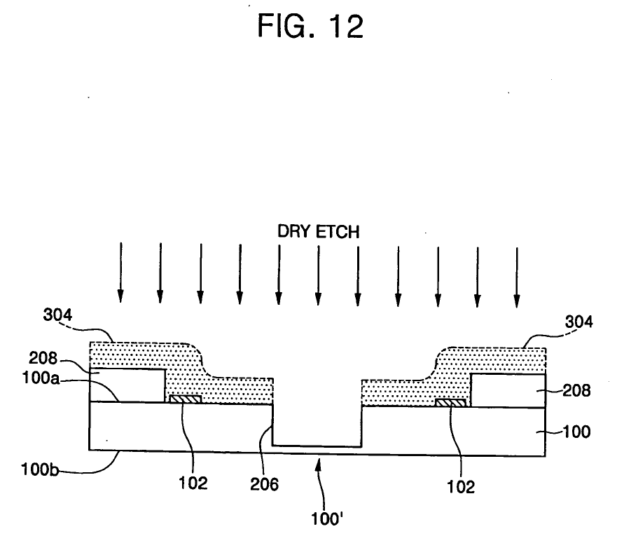

FIG. 12 is a cross-sectional view, taken along the line I-I′ of FIG. 1, illustrating a method of fabricating an ink jet head in accordance with another embodiment of the present general inventive concept.

Referring to FIGS. 1 and 12, the process of forming the ink-feed channel 206 described in FIG. 5 may be performed after forming the chamber layer 208 described in FIG. 6. That is, the chamber layer 208 defining sidewalls of an ink flow path may be formed on the top surface 100a of the substrate 100 that includes the pressure-generating elements 102 prior to the formation of the ink feed channel 206. A mask pattern 304 may then be formed on the top surface 100a having the chamber layer 208 thereon. The ink-feed channel 206 may then be formed in the substrate 100 by dry etching the substrate 100 using the mask pattern 304 as an etch mask. After removing the mask pattern 304, an ink jet head may be fabricated by performing the processes as described in FIGS. 6 to 11.

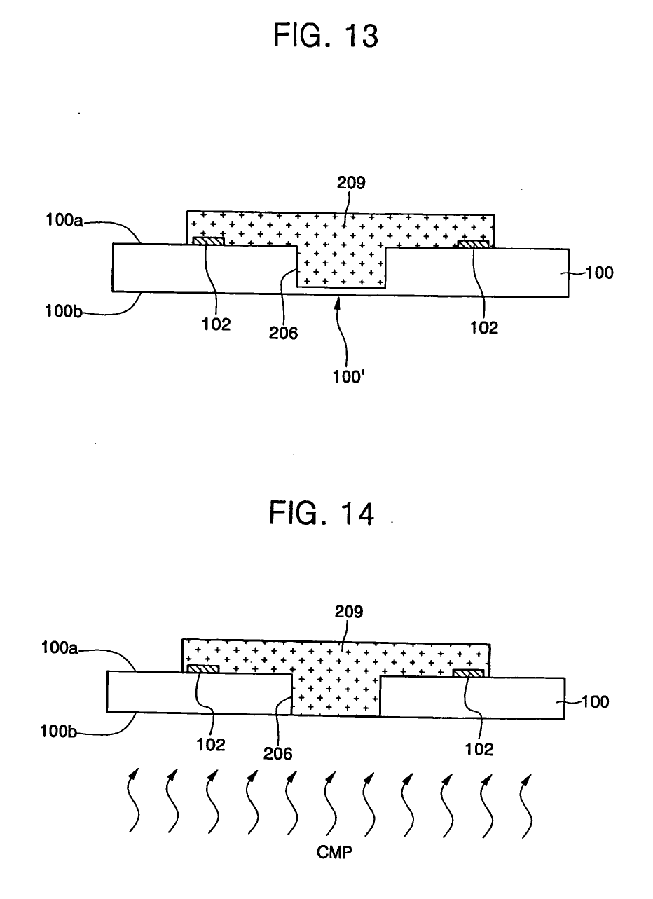

FIGS. 13 to 16 are cross-sectional views, taken along the line I-I′ of FIG. 1, illustrating a method of fabricating an ink jet head in accordance with another embodiment of the present general inventive concept.

Referring to FIGS. 1 and 13, the process described in FIG. 5 is performed to form the ink-feed channel 206 in the substrate 100 that includes the pressure-generating elements 102. A positive photosensitive resin layer or a thermoplastic resin layer may be formed on the top surface 100a of the substrate 100 having the ink-feed channel 206. The positive photosensitive resin layer or the thermoplastic resin layer may be patterned to form the sacrificial mold layer 209 to fill the ink-feed channel 206 and cover a region in which the ink flow path is to be formed.

Referring to FIGS. 1 and 14, after forming the sacrificial mold layer 209, the bottom surface 100b of the substrate 100 may be polished by the CMP process to remove the unetched portion 100′ (see FIG. 13). As a result, the bottom surface of the sacrificial mold layer 209 is exposed through the region from which the unetched portion 100′ is removed, and the ink feed channel 206 may extend through the substrate 100.

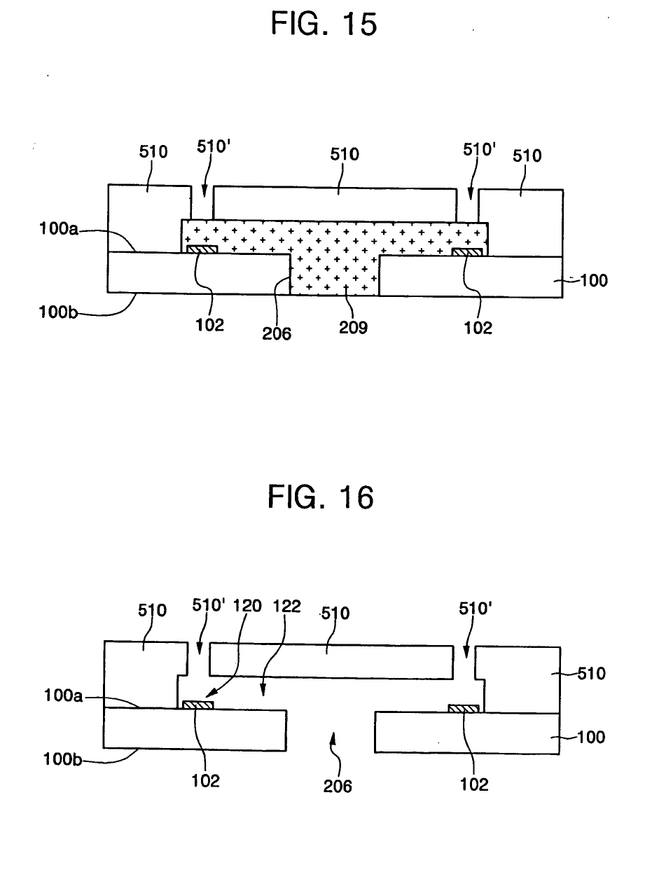

Referring to FIGS. 1 and 15, after removing the unetched portion 100′ (see FIG. 13), a chamber/nozzle material layer may be formed on the top surface 100a having the sacrificial mold layer 209. The chamber/nozzle material layer may be formed of a negative photosensitive resin layer or a thermosetting resin layer. The chamber/nozzle material layer may then be patterned to form a chamber/nozzle layer 510 having nozzles 510′ corresponding to the pressure-generating elements 102. The process of forming the chamber/nozzle layer 510 described in FIG. 15 may be formed prior to the process of removing the unetched portion 100′ described in FIG. 14. That is, the chamber/nozzle layer 510 may be formed on the top surface 100a having the sacrificial mold layer 209, and then the bottom surface 100b may be polished by the CMP process to remove the unetched portion 100′.

Referring to FIGS. 1 and 16, after forming the chamber/nozzle layer 510, or after removing the unetched portion 100′, the sacrificial mold layer 209 is dissolved and removed. As a result, the ink flow path including the ink chamber 120 and the ink channel 122 is formed in the region from which the sacrificial mold layer 209 is removed.

As can be seen from the foregoing, the methods of fabricating an ink jet head in accordance with various embodiments of the present general inventive concept performs the dry etching from the top surface of the substrate in order to form the ink-feed channel. As a result, the present general inventive concept is capable of improving yield and reliability of the ink jet head since shape and dimension of the ink-feed channel may be uniformly and reproducibly adjusted.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of fabricating an ink jet head, comprising:
preparing a substrate having first and second surfaces, the substrate being provided with a plurality of pressure-generating elements disposed on the first surface;
forming a mask pattern on the first surface on which the pressure-generating elements are disposed; and
forming an ink-feed channel extending through the substrate by dry etching the substrate from the first surface using the mask pattern as an etch mask.

2. The method according to claim 1, wherein the substrate is a silicon substrate.

3. The method according to claim 1, wherein dry etching the substrate is performed by one of:
a reactive ion etching (RIE) process; and
a deep reactive ion etching (DRIE) process.

4. The method according to claim 1, wherein the mask pattern is formed of one of a silicon oxide layer, a silicon nitride layer, a photoresist layer, a photosensitive resin layer, a metal layer, and a metal oxide layer.

5. The method according to claim 1, further comprising:
after forming the ink-feed channel, removing the mask pattern;
forming a chamber layer defining sidewalls of an ink flow path on the first surface of the substrate; and
forming a nozzle layer having a plurality of nozzles corresponding to the pressure-generating elements on the chamber layer.

6. The method according to claim 5, wherein the chamber layer is formed by patterning a photosensitive dry film layer.

7. A method of fabricating an ink jet head, comprising:
preparing a substrate having first and second surfaces, the substrate being provided with a plurality of pressure-generating elements disposed on the first surface;
forming a mask pattern on the first surface on which the pressure-generating elements are disposed;
forming an ink-feed channel in the substrate by partially dry etching the substrate from the first surface in order to leave an unetched portion having a predetermined thickness from the second surface using the mask pattern as an etch mask; and
removing the unetched portion by polishing the second surface of the substrate.

8. The method according to claim 7, wherein the substrate is a silicon substrate.

9. The method according to claim 7, wherein dry etching the substrate is performed by one of:
a reactive ion etching (RIE) process; and
a deep reactive ion etching (DRIE) process.

10. The method according to claim 7, wherein the unetched portion has a thickness of about 10˜50 μm.

11. The method according to claim 7, wherein the mask pattern is formed of one of a silicon oxide layer, a silicon nitride layer, a photoresist layer, a photosensitive resin layer, a metal layer, and a metal oxide layer.

12. The method according to claim 7, wherein polishing the second surface of the substrate is performed by a chemical mechanical polishing (CMP) process.

13. The method according to claim 7, further comprising:
after forming the ink-feed channel, removing the mask pattern;
forming a chamber layer defining sidewalls of an ink flow path on the first surface of the substrate; and
forming a sacrificial mold layer filling the ink flow path and the ink-feed channel between the sidewalls defined by the chamber layer.

14. The method according to claim 13, wherein forming the chamber layer comprises:
forming a photosensitive resin layer on the first surface of the substrate by means of a spin coating method; and
exposing and developing the photosensitive resin layer.

15. The method according to claim 13, wherein the sacrificial mold layer is formed of one of a positive photosensitive resin layer and a thermoplastic resin layer.

16. The method according to claim 13, further comprising:
after removing the unetched potion, forming a nozzle layer having a plurality of nozzles corresponding to the pressure-generating elements on the chamber layer and the sacrificial mold layer; and
dissolving and removing the sacrificial mold layer.

17. The method according to claim 13, further comprising:
after forming the sacrificial mold layer, forming a nozzle layer having a plurality of nozzles corresponding to the pressure-generating elements on the chamber layer and the sacrificial mold layer; and
after removing the unetched portion, removing the sacrificial mold layer.

18. The method according to claim 7, further comprising before forming the mask pattern, forming a chamber layer defining sidewalls of an ink flow path on the first surface of the substrate, the mask pattern being formed on the first surface having the chamber layer.

19. The method according to claim 18, further comprising:
after forming the ink-feed channel, removing the mask pattern; and
forming a sacrificial mold layer filling the ink flow path and the ink-feed channel between the sidewalls defined by the chamber layer.

20. The method according to claim 19, further comprising:
after removing the unetched portion, forming a nozzle layer having a plurality of nozzles corresponding to the pressure-generating elements on the chamber layer and the sacrificial mold layer; and
dissolving and removing the sacrificial mold layer.

21. The method according to claim 19, further comprising:
after forming the sacrificial mold layer, forming a nozzle layer having a plurality of nozzles corresponding to the pressure-generating elements on the chamber layer and the sacrificial mold layer; and
after removing the unetched portion, removing the sacrificial mold layer.

22. A method of fabricating an ink jet head, comprising:
preparing a substrate having first and second surfaces, the substrate being provided with a plurality of pressure-generating elements disposed on the first surface;
forming a mask pattern on the first surface on which the pressure-generating elements are provided;
forming an ink-feed channel in the substrate by partially dry etching the substrate from the first surface in order to leave an unetched portion having a predetermined thickness from the second surface using the mask pattern as an etch mask;
forming a sacrificial mold layer filling the ink-feed channel and covering a region in which an ink flow path is to be formed; and
removing the unetched portion by polishing the second surface of the substrate.

23. The method according to claim 22, wherein the substrate is a silicon substrate.

24. The method according to claim 22, wherein dry etching the substrate is performed by one of:
a reactive ion etching (RIE) process; and
a deep reactive ion etching (DRIE) process.

25. The method according to claim 24, wherein the unetched portion has a thickness of about 10˜50 μm.

26. The method according to claim 22, wherein the mask pattern is formed of one of a silicon oxide layer, a silicon nitride layer, a photoresist layer, a photosensitive resin layer, a metal layer, and a metal oxide layer.

27. The method according to claim 22, wherein polishing the second surface of the substrate is performed by a chemical mechanical polishing (CMP) process.

28. The method according to claim 22, further comprising:
after removing the unetched portion, forming a chamber/nozzle layer covering sidewalls and a top surface of the sacrificial mold layer and having a plurality of nozzles corresponding to the pressure-generating elements; and
dissolving and removing the sacrificial mold layer.

29. The method according to claim 22, further comprising:
after forming the sacrificial mold layer, forming a chamber/nozzle layer covering sidewalls and a top surface of the sacrificial mold layer and having a plurality of nozzles corresponding to the pressure-generating elements; and
after removing the unetched portion, removing the sacrificial mold layer.

30. A method of fabricating an ink jet head, comprising:
preparing a substrate having first and second surfaces, the substrate being provided with a plurality of pressure-generating elements disposed on the first surface;
forming a mask pattern on the first surface on which the pressure-generating elements are provided;
forming an ink-feed channel in the substrate by partially dry etching the substrate from the first surface in order to leave an unetched portion having a predetermined thickness from the second surface using the mask pattern as an etch mask;
removing the mask pattern;
forming a chamber layer defining sidewalls of an ink flow path on the first surface of the substrate having the ink-feed channel;
forming a sacrificial mold layer filling the ink flow path and the ink-feed channel between the chamber layers;
removing the unetched portion by polishing the second surface of the substrate by a chemical mechanical polishing process;
forming a nozzle layer having a plurality of nozzles corresponding to the pressure-generating elements on the chamber layer and the sacrificial mold layer; and
dissolving and removing the sacrificial mold layer.

31. A method of producing one or more ink jet heads, comprising:
providing a substrate having one or more pressure-generating elements to eject ink from the one or more ink jet heads, the one or more pressure generating elements being disposed on a first surface of the substrate; and
forming an ink feed-channel that extends through the substrate by dry etching the substrate from the first surface.

32. The method according to claim 31, wherein the one or more pressure-generating elements are arranged in two rows and the ink-feed channel is formed to have a single slot shape between the two rows.

33. The method according to claim 31, wherein the first surface of the substrate is etched by a reactive ion etching process.

34. The method according to claim 31, wherein the first surface of the substrate is etched by a deep reactive ion etching process.

35. The method according to claim 31, wherein the ink-feed channel is formed by the operations of:
forming a mask pattern on the first surface of the substrate having the pressure-generating elements; and
dry etching the first surface of the substrate including the mask pattern.

36. The method according to claim 32, further comprising:
forming a chamber layer defining sidewalls of an ink flow path on the first surface; and
forming a nozzle layer including nozzles corresponding to the pressure-generating elements above the chamber layer.
